(19) United States
(12) Patent Application Publication
(10) Pub. No.: US 2022/0327326 A1
(43) Pub. Date: Oct. 13, 2022

(54) EXECUTION OF APPLICATIONS WITH NEXT BEST MODELS APPLIED TO DATA

(71) Applicant: AT&T Intellectual Property I, L.P., Atlanta, GA (US)

(72) Inventors: Lauren Savage, Santa Clara, CA (US); Mark Austin, Allen, TX (US); Prince Paulraj, Coppell, TX (US); Ana Armenta, San Jose, CA (US); James Pratt, Round Rock, TX (US)

(21) Appl. No.: 17/226,908

(22) Filed: Apr. 9, 2021

(51) Int. Cl. G06K 9/62; G06N 20/00

(52) U.S. Cl. CPC G06K 9/623; G06K 9/6211; G06N 20/00; G06K 9/6262

(57) ABSTRACT

An example method includes receiving data to be provided to an application using a scoring model for calculating a score, determining that the data is incompatible with a current feature set of the scoring model applied by the application, receiving a next best model of features in response to the determining that the data is incompatible with the current feature set, executing the application to calculate the score with the data and the features of the next best model, and generating an output in accordance with the score.

The present disclosure relates generally to network applications that analyze data for scoring, and relates more particularly to a method, non-transitory computer-readable media, and apparatus for applying a next best model to data to be used by applications for executing a scoring model.

### BACKGROUND

Different types of data can be continuously generated by a variety of different sources. The data can be analyzed by applications to provide information, make predictions, guide decisions, and the like. For example, some types of data may be analyzed to detect fraud. Other types of data may be used to determine a next best action. Other types of data may be analyzed to make personalized recommendations (e.g., a suggested product, a suggested movie, and the like). Thus, data can be leveraged in a variety of different ways for a variety of different reasons.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for applying next best models to data for applications can be deployed;

FIG. 2 illustrates a flowchart of an example method for automatically applying a next best model to data that is provided to an application for executing a scoring model, in accordance with the present disclosure;

FIG. 3 illustrates a flowchart of an example method for automatically updating a ranking of a plurality of next best models, in accordance with the present disclosure; and

FIG. 4 depicts a high-level block diagram of a computing device or processing system specifically programmed to perform the functions described herein.

To facilitate understanding, similar reference numerals have been used, where possible, to designate elements that are common to the figures.

### DETAILED DESCRIPTION

The present disclosure broadly discloses methods, computer-readable media, and systems for automatically applying a next best model to data that is provided to an application for executing a scoring model. In one example, a method performed by a processing system includes receiving data to be provided to an application using a scoring model for calculating a score, determining that the data is incompatible with a current feature set of the scoring model applied by the application, receiving a next best model of features in response to the determining that the data is incompatible with the current feature set, executing the application to calculate the score with the data and the features of the next best model, and generating an output in accordance with the score.

In another example, a non-transitory computer-readable medium may store instructions which, when executed by a processing system in a communications network, cause the processing system to perform operations. The operations may include receiving data to be provided to an application using a scoring model for calculating a score, determining that the data is incompatible with a current feature set of the scoring model applied by the application, receiving a next best model of features in response to the determining that the data is incompatible with the current feature set, executing the application to calculate the score with the data and the features of the next best model, and generating an output in accordance with the score.

In another example, a device may include a processing system including at least one processor and non-transitory computer-readable medium storing instructions which, when executed by the processing system when deployed in a communications network, cause the processing system to perform operations. The operations may include receiving data to be provided to an application using a scoring model for calculating a score, determining that the data is incompatible with a current feature set of the scoring model applied by the application, receiving a next best model of features in response to the determining that the data is incompatible with the current feature set, executing the application to calculate the score with the data and the features of the next best model, and generating an output in accordance with the score.

As discussed above, different types of data can be continuously generated by a variety of different sources. The data can be analyzed by applications to provide information, make predictions, guide decisions, and the like. For example, some types of data may be analyzed to detect fraud. Other types of data may be used to determine a next best action. Other types of data may be analyzed to make personalized recommendations (e.g., a suggested product, a suggested movie, and the like).

However, the data may be outdated, incomplete, missing data, incompatible with a current feature set applied by the application, and the like. Thus, the incomplete data may cause the application to calculate the scoring model incorrectly, which may lead to an inaccurate output (e.g., a false positive for fraud detection, an incorrect next action or control, an inaccurate recommendation, and the like). In other instances, there may not be enough data available to provide a level of confidence for the scoring model calculated by the application. Unfortunately, some systems may not allow for partial answers.

Examples of the present disclosure may provide a data quality monitor, expected feature set, and a next best model service that may allow the applications to calculate the scoring model with the expected confidence level even when the available data is incomplete. The data quality monitor and the expected feature set may detect when there is an incompatibility between the data and the features of the currently used model. The incompatibility may be due to either outdated or missing data detected by the data quality monitor or due to inaccurate features in the current model for the available data detected by the expected feature set. When incompatibility is detected either due to bad data or bad features in the current model, the present disclosure may apply a next best model.

The next best model may be selected from a ranked list of available next best models. The ranked list may be continuously updated based on time (e.g., holiday shopping season, summer months when people travel more frequently, and the like) or based on changes to weighting of data used to calculate the scoring model. For example, it may be determined that over time some categories of data may have less of an effect on the scoring model. As such, the next best models may be re-ranked to lower the ranking of models that use features that account for the data that is determined to be less important.

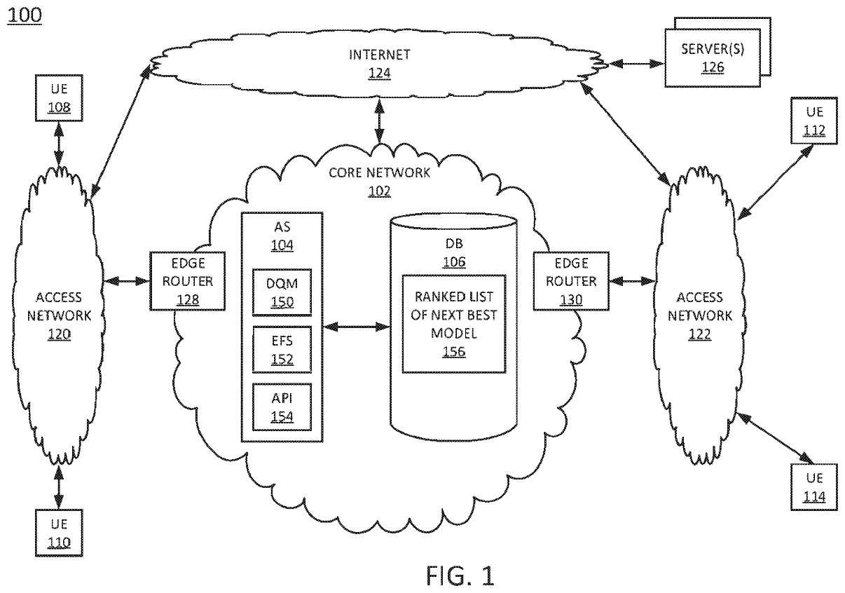

The next best model may be selected and applied to the data. As a result, the applications may be able to calculate a scoring model within the expected confidence level. The result of the scoring model may be used by the application to generate an output (e.g., a detection of fraud, a next step, a control decision for a device, a recommendation, and the like). These and other aspects of the present disclosure are discussed in greater detail below in connection with the examples of FIGS. 1-4.

To further aid in understanding the present disclosure, FIG. 1 illustrates an example system 100 in which examples of the present disclosure for applying a next best model to data to be used by applications for executing a scoring model can be deployed. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, at least one database (DB) 106, and a plurality of edge routers 128-130. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3rd party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider. The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

In one example, the access network 120 may be in communication with one or more user endpoint devices 108 and 110. Similarly, the access network 122 may be in communication with one or more user endpoint devices 112 and 114. The access networks 120 and 122 may transmit and receive communications between the user endpoint devices 108, 110, 112, and 114, between the user endpoint devices 108, 110, 112, and 114, the server(s) 126, the AS 104, other components of the core network 102, devices reachable via the Internet in general, and so forth. In one example, each of the user endpoint devices 108, 110, 112, and 114 may comprise any single device or combination of devices that may comprise a user endpoint device. For example, the user endpoint devices 108, 110, 112, and 114 may each comprise a mobile device, a cellular smart phone, a gaming console, a set top box, a laptop computer, a tablet computer, a desktop computer, an Internet of Things (IoT) device, a wearable smart device (e.g., a smart watch, a fitness tracker, a head mounted display, or Internet-connected glasses), an application server, a bank or cluster of such devices, and the like.

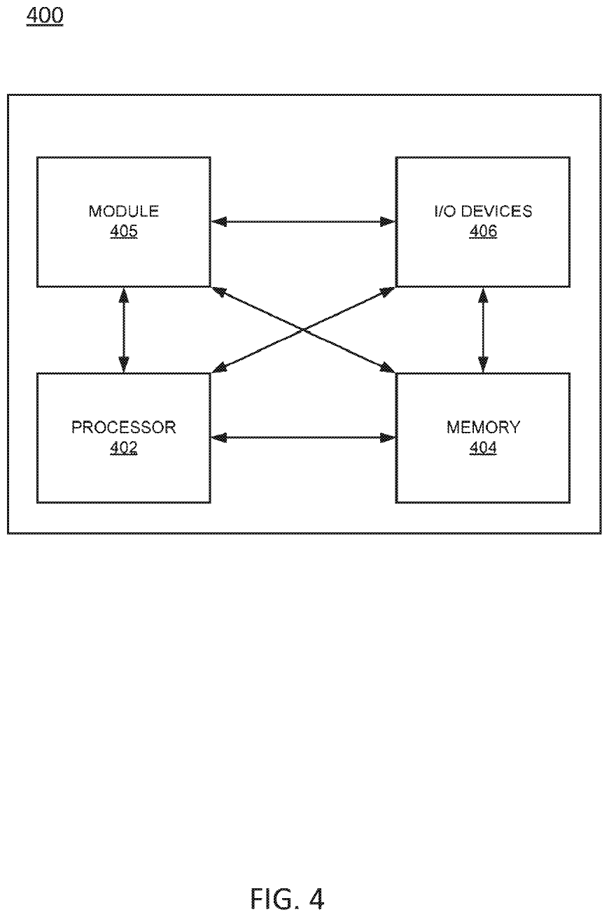

To this end, the user endpoint devices 108, 110, 112, and 114 may comprise one or more physical devices, e.g., one or more computing systems or servers, such as computing system 400 depicted in FIG. 4, and may be configured as described below.

In one example, one or more servers 126 may be accessible to user endpoint devices 108, 110, 112, and 114 via Internet 124 in general. The server(s) 126 may operate in a manner similar to the AS 104, which is described in further detail below. The servers 126 may be servers that conduct transactions or generate various types of data. The servers 126 may be located at retail outlets or enterprise companies.

In one embodiment, the endpoint devices 108, 110, 112, and 114 and the servers 126 may generate various types of data that can be analyzed by applications executed by the AS 104. The data may be analyzed to calculate a score by a scoring model of a particular application for a particular output by the AS 104. For example, the application may have a scoring model to calculate a score using the data. A model with a feature set may be applied by the scoring model to the data to calculate the score. The score may be a percentage or a confidence score of the likelihood of an event being detected (e.g., percent confidence that a transaction is fraudulent, percent confidence that a data packet should be re-routed, percent confidence that a recommendation is appropriate for a user, and the like). Thus, examples herein that may refer to “calculating a scoring model” may refer to the process of calculating a score based on a scoring model of a particular application, as described above.

One application may calculate a score to determine if a transaction is fraudulent, another application may calculate a score for the data to determine a control decision for a network element, and so forth. The scoring model may provide a score based on the data and the score may be compared to a threshold or confidence interval. Based on the comparison, the application may generate the appropriate output which can be returned to the endpoint devices 108, 110, 112, 114, or servers 126 that provided the data.

However, as noted above, some data may be incomplete given the features of a model that are used to analyze the data. In other words, the data may be incompatible with the features of the current model that are to be applied. A feature of a model may be a function that is applied to a particular category of data of the data that is received. The data may include many different categories of data and a different feature of the model may be applied to each category of data. For example, the data may be a data vector of (a, b, and c). The model may include features of x, y, and z that are applied to data a, b, and c. As a result the model may be a score=ax+by+cz. In one example, the categories for fraud detection may comprise recent purchase data category (e.g., last 30 days, last two weeks, etc.), credit score data category (e.g., credit score of the purchaser, credit score of the spouse of the purchaser, collective credit score of the purchaser's household, etc.), location data category (e.g., current location of the current purchase, historical locations of prior purchases, historical presence locations of the purchaser, e.g., last 24 hours, last week, etc.), dollar amount spending data category (e.g., the spending amount of the purchaser in the last 24 hours, in the last week, in the last month, etc.), goods and services data category (e.g., the typical type of goods and/or services purchased by the purchaser), travel data category (e.g., flight information, hotel reservation information, car rental information, credit charges outside the country of residence of the purchaser, etc.) and the like. In another example, the categories for device control application (e.g., a network intrusion detection and prevention application) may comprise recent network traffic volume data category (e.g., last hour, last 24 hours, last two weeks, last 30 days, etc.), session setup data category (e.g., number of communication session setups, locations of origination and/or destinations (e.g., IP addresses) of communication session setups, time duration of communication session setups, etc.), location data category (e.g., current location of an endpoint device, historical detected locations of the endpoint device, historical time duration of the endpoint device at a particular location, e.g., last 24 hours, last week, etc.), authentication data category (e.g., the authentication mechanism that was used to setup a communication session, the password used, the last time the password was updated, the user name used to setup the communication session, the last time the user name was changed, the level of authentication used (single level authentication or multilevel authentication), the number of authentication attempts, etc.), white list or black list data category (e.g., is the requesting endpoint device of the communication session on a white list or a black list, is the destination endpoint device of the communication session on a white list or a black list, is the IP address of the requesting endpoint device of the communication session on a white list or a black list, is the IP address of the destination endpoint device of the communication session on a white list or a black list, etc.), network device control data category (e.g., network devices supporting a communication session, network devices that can terminate a communication session, network devices that can track and trace traffic on a communication session), and the like. In another example, the categories for match detection or recommendation generation may comprise recent purchase data category (e.g., last 30 days, last two weeks, etc.), media content data category (e.g., media content consumption of a user, media content consumption of the user's spouse, collective media content consumption of the user's household, etc.), location data category (e.g., current location of the user, historical presence locations of the user, e.g., last 24 hours, last week, etc.), dollar amount spending data category (e.g., the spending amount of the user in the last 24 hours, in the last week, in the last month, etc.), goods and services data category (e.g., the typical type of goods and/or services purchased by the user), travel data category (e.g., flight information, hotel reservation information, car rental information, credit charges outside the country of residence of the user, etc.) and the like.

It should be noted that the above is only a simplified example and that the features and models may be more complex. In addition, each feature may be weighted differently. For example, some features may have a larger effect on the score than other features.

When the data is incomplete or the current model lacks features for the data that is received, then the current model may provide an inaccurate scoring model. As a result, the wrong or inaccurate output may be provided back to the endpoint devices 108, 110, 112, 114, or servers 126 that provided the data. The present disclosure provides a next best model that can be applied to the data to generate an accurate output even when the incompatibility between the data and the current model is detected (e.g., either the data is incomplete or the features of the current model do not match an expected feature set for the data).

In accordance with the present disclosure, the AS 104 and DB 106 may be configured to provide one or more operations or functions in connection with examples of the present disclosure for automatically applying a next best model to data that is provided to an application for executing a scoring model, as described herein. For instance, the AS 104 may include a data quality monitor (DQM) 150, an expected feature set (EFS) 152, and one or more application programing interfaces (APIs) 154. The DB 106 may store a ranked list of next best models 156.

In one embodiment, the DQM 150 may analyze the data received from the endpoint devices 108, 110, 112, 114, or servers 126 that provided the data. The DQM 150 may detect when the data is incomplete. For example, the data may be outdated. For example, current data may not be available (e.g., due to an outage, interruption or degradation of a data source, e.g., a break in a network connection, a power outage, a weather event, and so on), and as a result an endpoint device may send data from a week ago. Thus, the confidence of the source data is now in question.

In another example, some data from a series of data may be missing. For example, there may have been a network outage. As a result, two hours of data may be missing for a 24 hour period.

In another example, some categories of data may be missing. For example, the DQM 150 may expect certain types of data for a particular API 154. Without all of the types of data, the scoring model executed by the API 154 may provide an inaccurate output.

In one embodiment, the DQM 150 may communicate with the endpoint devices 108, 110, 112, 114, or servers 126 that provided the data. The DQM 150 may query the endpoint devices 108, 110, 112, 114, or servers 126 that provided the data to determine what data is missing or to confirm that the data is complete or incomplete.

In one embodiment, the EFS 152 may store the expected feature set for a current model. In one embodiment, the EFS 152 may store different feature sets for different models that are used by different APIs 154 to execute a scoring model for that particular API 154. The EFS 152 may periodically update or change the expected features set for a model for a particular API 154. For example, over time some features may be found to be less reliable or less predictive for a model when executing the scoring model for the API 154. As a result, the expected feature set may be changed and/or learned if a machine learning model is employed.

In another example, a different feature set may be used when the data is incomplete or unreliable. For example, a user may be at a location that is indoors with a weak network signal. As a result, throughput data of the endpoint device may be unreliable due to the location of the user. Thus, a feature that is applied to throughput data may provide an inaccurate measure of network reliability at a particular location. In response, the EFS 152 may be updated with a different feature set.

In one embodiment, when an API 154 applies a current model, the model may check the feature set of the current model with the EFS 152 to ensure that the feature sets match. If the feature sets do not match, then an incompatibility between the data and the feature set may be detected. In some instances, the wrong feature set may be used by the current model even though the correct and/or complete data set is received from the endpoint devices 108, 110, 112, 114, or servers 126. In other words, an incompatibility between the data and feature set may be detected due to incomplete data, a wrong feature set being selected, or both incomplete data and a wrong feature set being selected.

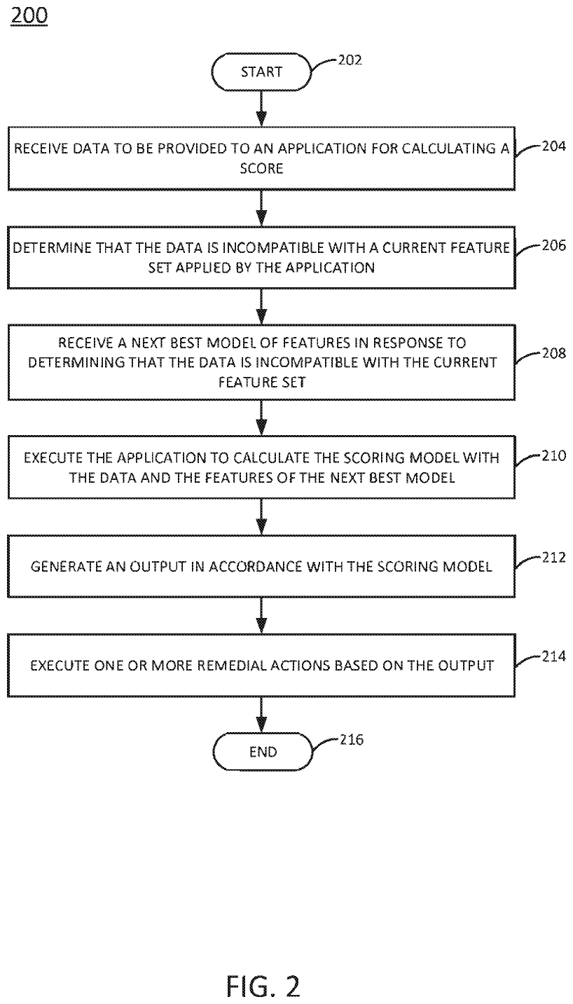

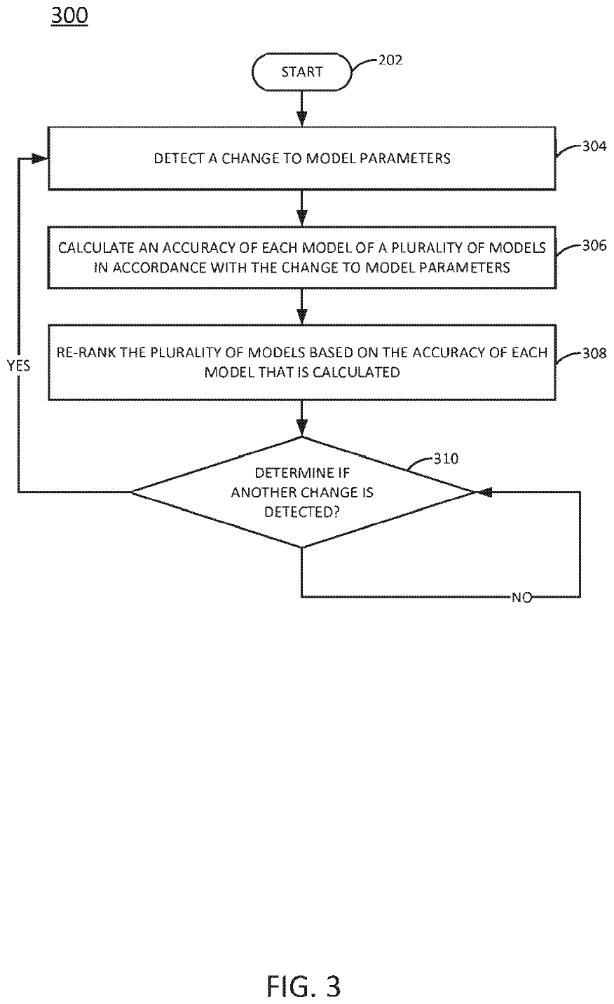

When an incompatibility between the data and the feature set is detected, the AS 104 may receive or select the next best model from the ranked list of next best models 156 stored in the DB 106. In one example, DB 106 may comprise a physical storage device integrated with the AS 104 (e.g., a database server or a file server), or attached or coupled to the AS 104, in accordance with the present disclosure. In one example, the AS 104 may load instructions into a memory, or one or more distributed memory units, and execute the instructions for automatically applying a next best model to data that is provided to an application for executing a scoring model or automatically updating a ranking of a plurality of next best models, as described herein. Example methods for automatically applying a next best model to data that is provided to an application for executing a scoring model and automatically updating a ranking of a plurality of next best models are described in greater detail below in connection with FIGS. 2 and 3.

In one embodiment, the next best model may provide the best features to be applied for the data that is available to allow the API 154 to execute the scoring model accurately and provide a reliable output. In one embodiment, the ranked list of next best models 156 may be continuously updated. For example, as changes to model parameters are detected, the accuracy of the models may be re-calculated and re-ranked.

The changes to the model parameters may include changes to the time of day, time of year, changes to costs to execute a model, and the like. For example, for fraud detection APIs 154, some models may include features that reduce the weight associated with purchase amounts for detecting fraud during the holiday shopping season between November to December. For example, customers may purchase more expensive items during the holidays. In another example, some models may include features that reduce the weight of location data for detecting fraud during the summer as more people tend to travel during the summer (e.g., June through August).

In another example, model parameters may include changes to weighting of different categories of data over time. For example, over time it may be determined that online transactions are less indicative of potential fraud, as more people shop from home rather than brick and mortar stores. In another example, it may be determined that selections made by a female occupant in the home may have more influence than a male occupant. Thus, gender data may be weighted more heavily for scoring model APIs 154 that calculate an accuracy of a recommendation.

In one embodiment, the models may be re-computed dynamically based on changes to the number of features. As noted above, the model parameters may change and cause some features to be removed. Thus, the next best models may be retrained and computed with a certain number of less features.

In one embodiment, the models may be used “as is” with features removed. However, the missing features may be “imputed” or replaced with substitute values. For example, the substitute values may be averages, a median, a zero value, and the like.

In one embodiment, the next best model may be re-ranked based on models chosen from a set of pre-computed models. For example, the pre-computed models may be variations of the models with different features missing. Although all combinations of missing features may not be pre-computed, historical data can be used to determine which models with missing features should be pre-computed. For example, historical data may allow a probabilistic approach to compute which features are missed most often to select which combination of features to pre-compute for the re-ranking of the ranked list of next best models 156. The highest probability next best models can be selected for pre-computing and re-ranking.

In one embodiment, a decision tree approximation may be used. For example, the leaf nodes in the decision tree may be representative of features. Depending on which leaf nodes in the decision tree are missing, some portions of the decision tree may be eliminated as it may not have a significant prediction impact or effect on the calculated score.

In another example, costs to execute each model may be considered when ranking the plurality of next best models. Costs may be measured in an amount of time it takes for a model to be applied to the data, an amount of processing resources (e.g., processor usage, memory usage, and the like) consumed by the model, and the like. For example, if two models provide similar accuracy, the model that is cheaper to use may be ranked higher. In another example, a lower cost model may be ranked higher if the difference in accuracy is lower than a difference threshold (e.g., within 1% of each other). In another example, if two models provide similar accuracy, the model that is faster in producing its output may be ranked higher.

In another example, the next best models may be re-ranked based on the data that is received. For example, the current model may use features that expect four different data categories. However, only three data categories may be received. Thus, the current feature set may not be accurate and a next best model may be selected. The next best models may be re-ranked based on the most accurate next best model that does not use a feature for the category of data that is missing.

It should be noted that the above are only a few examples and other examples may be evident. It should also be noted that any combination of one or more of the different changes of parameters may cause the ranked list of next best models to be re-ranked.

In one embodiment, a known data set may be used to recalculate an accuracy of the models for re-ranking based on the detected changes to the model parameters. For example, the known data set may have a known output. The data set that reflects the changes to the model parameters may be fed to each of the models in the ranked list of next best models 156. The outputs may then be compared to the known output of the known data set. The models may then be re-ranked based on having the closest accuracy to the known or expected output.

The rankings of the models in the ranked list of next best models 156 may be periodically updated. For example, the rankings may be updated every day, every week, every month, and the like. In one embodiment, the rankings may be updated each time a change to a model parameter is detected.

Thus, the AS 104 may apply a next best model to incomplete data and/or inaccurate feature sets in a current model. As a result, an accurate output may be generated by scoring models that are executed by the APIs 154 for a particular application. The application may include fraud applications to detect fraud, device control applications to make a control decision for a device (e.g., routing decisions for a network element), matching applications to determine a match (e.g., movie recommendations, match making applications, product recommendations, and the like), or any other type of application that uses scoring models to generate an output.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, UE devices 108, 110, 112, and 114 may communicate with the core network 102 via different access networks, user endpoint devices 110 and 112 may communicate with the core network 102 via different access networks, and so forth. Thus, these and other modifications are all contemplated within the scope of the present disclosure.

FIG. 2 illustrates a flowchart of an example method 200 for automatically applying a next best model to data that is provided to an application for executing a scoring model, in accordance with the present disclosure. In one example, steps, functions and/or operations of the method 200 may be performed by a device as illustrated in FIG. 1, e.g., AS 104 or any one or more components thereof. In one example, the steps, functions, or operations of method 200 may be performed by a computing device or system 400, and/or a processing system 402 as described in connection with FIG. 4 below. For instance, the computing device 400 may represent at least a portion of the AS 104 in accordance with the present disclosure. For illustrative purposes, the method 200 is described in greater detail below in connection with an example performed by a processing system, such as processing system 402.

The method 200 begins in step 202 and proceeds to step 204. In step 204, the processing system may receive data to be provided to an application using a scoring model for calculating a score. For example, an endpoint and/or a server of a customer may send data to be analyzed by an API or application. The data may include different categories of data that may be analyzed by the application to generate an output based on execution of a scoring model. For example, the application may be a fraud detection application, a device control application (e.g., a network intrusion detection and prevention application), a matching application, and the like.

In step 206, the processing system may determine that the data is incompatible with a current feature set applied by the application. For example, a DQM may detect that the data is incomplete and/or an EFS may detect that the features of the current model do not match an expected feature set for the current model being used by an application selected to analyze the data.

As described above, the incompatibility between the data and the current feature set may be determined due to incomplete data, an incorrect feature set for the current model, or both incomplete data and an incorrect feature set for the current model. In one embodiment, the data may be incomplete due to the data being out dated, missing data within a sequence of the data, identification of a missing category of data, and the like. In one embodiment, the processing system may contact the endpoint device of the user or customer that sent the data to confirm that the data is outdated, missing data, or missing an entire category of data.

In one embodiment, the incorrect features of the current model may be detected by comparing the features of the current model to the EFS. When a mismatch is detected, the processing system may determine that a different model with the appropriate or correct features should be applied by the application to execute the scoring model.

In step 208, the processing system may receive a next best model of features in response to determining that the data is incompatible with the current feature set. For example, the processing system may select the highest ranked model in a ranked list of next best models.

In step 210, the processing system may execute the application to calculate the scoring model with the data and the features of the next best model. For example, the application may calculate a score for the data using the features of the next best model.

In step 212, the processing system may generate an output in accordance with the scoring model. For example, the score calculated by the application may be compared to a threshold. Based on the comparison, an output may be generated. For example, the threshold may be a confidence level that fraud is detected (e.g., 0.99). The application may calculate a score of 0.995. The score may be compared to the threshold 0.99. Since the score is greater than the threshold, the processing system may determine that fraud has been detected. The output (e.g., fraud is detected) may be transmitted back to the endpoint device that provided the data (e.g., a point of sale device, or a credit card company server for authorizing a purchase using a credit card; a network decision device, e.g., a firewall device or a network router for deciding whether network traffic is to be forwarded to a destination; a recommendation server for deciding whether a particular recommendation is to be provided to a user device (e.g., a recommended media content selection, a recommended travel route on a navigation device, a recommended network route (e.g., specific links and nodes) for establishing a communication session, and so on).

In step 214, the processing system (or another separate and distinct system dedicated to execute remedial actions) may execute one or more remedial actions based on the output of step 212. For example, in fraud detection, the output indicating fraud may trigger a remedial action such as terminating an attempt to make or complete a purchase of an item, e.g., denying a credit card transaction (e.g., sending a warning signal to a credit card company server), tracing a physical location of a credit card, tracing an IP address of a financial transaction, tracing a physical location of a point of sale, tracing a physical location of an endpoint device (e.g., a cellular endpoint device associated with the purchaser), notifying a law enforcement agency, notifying a user affected by the fraudulent activities, notifying a credit rating agency, notifying a financial institution (e.g., a bank or a credit union), shutting down access to an account, e.g., a credit card account, a bank account, a debit card account, etc., notifying a personnel located at the point of sale, shutting down a purchased device that is the subject of the fraud, e.g., terminating cellular service to a fraudulently purchased cellular phone, locating the physical location of the fraudulently purchased item (e.g., the location of a cellular phone, the location of a vehicle, etc.) and the like.

For another example, in a device control application (e.g., a network intrusion event is detected or a potential network failure event or a network degradation event is detected), the output indicating that a device requires a new control may trigger a remedial action such as terminating an attempt to establish a communication session, e.g., denying an authentication request, challenging an attempt to establish a communication session, e.g., implementing a multilevel authentication process, tracing a physical location of an endpoint device requesting the session setup (e.g., a cellular endpoint device associated with the user making the request), tracing an IP address of an endpoint device requesting the session setup, tracing or logging a physical location of a network edge element from which the request originated, tracing a physical location of a destination endpoint device of the communication session, notifying a law enforcement agency of the potential network intrusion, notifying a user or a system affected by the network intrusion (e.g., notifying the destination end user of the communication session, notifying a network monitoring server of the network service provider, notifying a network service provisioning system, etc.), shutting down a communication session that was already established, e.g., disconnecting the end users from the communication session, directing the destination of the communication session to a honey pot, etc., notifying a maintenance personnel to visit a location that the communication session originated from, activating a recording network element to record potential fraudulent activities occurring on the communication session, recording the originating IP address into a black list to prevent future network access, and the like.

For another example, in a matching recommendation application, the output indicating a potential match may trigger a remedial action such as sending a recommendation (e.g., an electronic notification such as a text or an email) to a user endpoint device to complete a transaction or make a purchase (e.g., a hotel room, an airline flight or a media content to be streamed matching a user profile is now available), actually completing the transaction (e.g., reserving the hotel room, reserving the airline flight or downloading the media content using the user's credit card account or bank account), notifying a third party entity to reach out to the user (e.g., notifying a cruise ship company to offer the user a cruise date and itinerary), negotiating automatically on behalf of the user (e.g., detecting an offer is near a threshold specified by the user, e.g., automatically asking a hotel to further lower a room rate to $200 from a recently announced special rate of $225 to meet the user's specified preference for a $200 room, or automatically asking a car dealer to further lower a car price to $20,000 from a recently announced special rate of $21,000 to meet the user's specified preference for a $20,000 car), and the like. It should be noted that any remedial actions that are taken on behalf of the user and/or impacts the privacy of the user (e.g., monitoring of the user activities or the use of the user's financial information to complete a transaction for the user) will require the user's affirmative consent. In other words, the user must opt-in to such services before such remedial actions can be taken. The method 200 may end in step 216.

FIG. 3 illustrates a flowchart of an example method 300 for automatically updating a ranking of a plurality of next best models, in accordance with the present disclosure. In one example, steps, functions and/or operations of the method 300 may be performed by a device as illustrated in FIG. 1, e.g., AS 104 or any one or more components thereof. In one example, the steps, functions, or operations of method 300 may be performed by a computing device or system 400, and/or a processing system 402 as described in connection with FIG. 4 below. For instance, the computing device 400 may represent at least a portion of the AS 104 in accordance with the present disclosure. For illustrative purposes, the method 300 is described in greater detail below in connection with an example performed by a processing system, such as processing system 402.

The method 300 begins in step 302 and proceeds to step 304. In step 304, the processing system may detect a change to model parameters. For example, over time parameters that may affect the accuracy of the model for an application may change. The model parameters may include a time (e.g., time of day, day of the week, month of the year, season, and the like), changes to a weighting of different categories of data, changes to costs to apply a model, changes based on the different categories of data that are received, and the like.

To illustrate, different models may be more accurate during different time periods. For example, some models may include features that can detect fraud more accurately in the holiday shopping months than other models. In another example, some models can detect fraud more accurately during the summer when people are traveling more frequently than other models. In another example, some models can detect network intrusion more accurately based upon the type of data being accessed, source IP addresses of the requests, destination IP addresses of the requests, time of day of the requests, geographical locations of the originating requests, network edge elements of the originating requests, and so on than other models. In another example, some models can provide better matched recommendations more accurately based upon the type of data (e.g., media content consumption, purchased items, travel routes taken, vacation trips taken, and so on), time of day of the actions taken, months or seasons of the year of the actions taken, geographical locations of the actions taken, network elements (e.g., network servers providing various services such as media content distribution or streaming services, travel planning services, route navigation services, and so on) that assisted in the actions taken, and so on than other models.

In another example, over time it may be determined that some categories of data may no longer have an effect on an outcome or prediction. As a result, those models that include features that heavily weight those categories of data may be less accurate (e.g., production or sale of a product has been discontinued, a network service is discontinued, a financial transaction mechanism is discontinued, a parameter in computing a credit score is discontinued, a potential security loop hole in a network environment has been eliminated, a network element is taken offline, and so on). Thus, other models that do not use those features may be ranked higher.

In step 306, the processing system may calculate an accuracy of each model of a plurality of models in accordance with the change to the model parameters. For example, a known data set with a known output given the changes to the model parameters for the scoring model may be applied to the models in the ranked list of next best models. Each of the models may be used to execute a scoring model with the known data set.

In step 308, the processing system may re-rank the plurality of models based on the accuracy of each model that is calculated. For example, the scores calculated with the features of each model may be compared to the known score. The models may be re-ranked based on the accuracy of the calculated score to the known score for the known data set.

In step 310, the processing system may determine if another change is detected. The method 300 may continuously operate to re-rank the plurality of models as changes to model parameters are detected. In one embodiment, the method 300 may be performed periodically (e.g., every day, every week, once a month, and the like). In one embodiment, the method 300 may be performed whenever a change is detected.

It should be noted that the methods 200 and 300 may be expanded to include additional steps or may be modified to include additional operations with respect to the steps outlined above. In addition, although not specifically specified, one or more steps, functions, or operations of the methods 200 and 300 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 or FIG. 3 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for automatically applying a next best model to data that is provided to an application for executing a scoring model, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 or 300 as discussed above is implemented in a distributed or parallel manner for a particular illustrative example, i.e., the steps of the above method 200 or 300 or the entire method 200 or 300 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200 or 300. In one example, instructions and data for the present module or process 405 for automatically applying a next best model to data that is provided to an application for executing a scoring model (e.g., a software program comprising computer-executable instructions) can be loaded into memory 404 and executed by hardware processor element 402 to implement the steps, functions, or operations as discussed above in connection with the illustrative method 200 or 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for automatically applying a next best model to data that is provided to an application for executing a scoring model (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
receiving, by a processing system including at least one processor, data to be provided to an application using a scoring model for calculating a score;
determining, by the processing system, that the data is incompatible with a current feature set of the scoring model applied by the application;
receiving, by the processing system, a next best model of features in response to the determining that the data is incompatible with the current feature set;
executing, by the processing system, the application to calculate the score with the data and the features of the next best model; and
generating, by the processing system, an output in accordance with the score.

2. The method of claim 1, wherein the determining that the data is incompatible with the current feature set comprises determining that the data is incomplete.

3. The method of claim 2, wherein the determining that the data is incomplete comprises identifying missing data within a sequence of the data.

4. The method of claim 2, wherein the determining that the data is incomplete comprises identifying a missing category of data.

5. The method of claim 1, wherein the determining that the data is incompatible with the current feature set comprises determining that the data is outdated.

6. The method of claim 1, wherein the determining that the data is incompatible with the current feature set comprises determining that the current feature set fails to include a feature associated with a category of data included in the data.

7. The method of claim 1, wherein the determining that the data is incompatible with the current feature set comprises determining that the current feature set includes a feature associated with a category of data that is missing in the data.

8. The method of claim 7, wherein the determining that the current feature set includes the feature associated with the category of data that is missing in the data comprises:
comparing, by the processing system, the current feature set to an expected feature set; and
determining, by the processing system, that the current feature set does not match the expected feature set.

9. The method of claim 1, wherein the determining comprises:
communicating, by the processing system, with an external source of the data to verify that the data is complete or current.

10. The method of claim 1, wherein the determining comprises:
executing, by the processing system, the application to calculate the score with the data and the current feature set; and
determining, by the processing system, that the score is outside an expected scoring range.

11. The method of claim 1, wherein the next best model comprises a highest ranked model of a plurality of models.

12. The method of claim 11, wherein a ranking of the plurality of models is continuously updated.

13. The method of claim 12, wherein the ranking of the plurality of models is updated based on a current time.

14. The method of claim 12, wherein the ranking of the plurality of models is updated based on at least one change to a weighting of different categories of data included in the data.

15. The method of claim 12, wherein the ranking of the plurality of models is updated based on at least one change to a cost to execute the scoring model.

16. The method of claim 12, wherein the ranking of the plurality of models is updated based on a re-computation of the models with a change in a number of features associated with the models.

17. The method of claim 12, wherein the ranking of the plurality of models is updated based on a set of pre-computed models for different combinations of features.

18. The method of claim 1, further comprising:
executing at least one remedial action in response to the output.

19. A non-transitory computer-readable medium storing instructions which, when executed by a processing system including at least one processor, cause the processing system to perform operations, the operations comprising:
receiving data to be provided to an application using a scoring model for calculating a score;
determining that the data is incompatible with a current feature set of the scoring model applied by the application;
receiving a next best model of features in response to the determining that the data is incompatible with the current feature set;
executing the application to calculate the score with the data and the features of the next best model; and
generating an output in accordance with the score.

20. A device comprising:
a processing system including at least one processor; and
a non-transitory computer-readable medium storing instructions which, when executed by the processing system, cause the processing system to perform operations, the operations comprising:
receiving data to be provided to an application using a scoring model for calculating a score;
determining that the data is incompatible with a current feature set of the scoring model applied by the application;
receiving a next best model of features in response to the determining that the data is incompatible with the current feature set;
executing the application to calculate the score with the data and the features of the next best model; and
generating an output in accordance with the score.
